(19) United States
(12) Patent Application Publication
(10) Pub. No.: US 2010/0231623 A1
(43) Pub. Date: Sep. 16, 2010

(54) Image Forming Apparatus And Mist Recovery Method

(76) Inventor: Katsuyuki Hirato, Ashigarakami-gun (JP)

Correspondence Address: FISH & RICHARDSON P.C., PO BOX 1022, MINNEAPOLIS, MN, 55440-1022, US

(21) Appl. No.: 12/723,571

(22) Filed: Mar. 12, 2010

(30) Foreign Application Priority Data
Mar. 13, 2009 (JP) 2009061678

(51) Int. Cl. B41J 29/38; B41J 2/165

(52) U.S. Cl. 347/10; 347/34

(57) ABSTRACT

The image forming apparatus includes: an inkjet head of an on-demand ejection type having a nozzle plate in which a nozzle electrode is arranged in a vicinity of a nozzle through which liquid is ejected; and a voltage application device which makes a polarity of the nozzle electrode one of positive and negative in accordance with a start of an ejection operation of the liquid, and then switches the polarity of the nozzle electrode to an opposite polarity to the one of positive and negative in accordance with a timing of ejecting the liquid through the nozzle.

### BACKGROUND OF THE INVENTION

1. Field of the Invention

The present invention relates to an image forming apparatus and a mist recovery method, and more particularly to technology for preventing the adherence, to a liquid ejection face, of droplets in the form of a mist generated when the liquid is ejected from an inkjet head.

2. Description of the Related Art

An image forming apparatus which forms an image by ejecting and depositing ink or a functional material onto a recording medium using an inkjet head is excellent from an environmental viewpoint and enables high-speed recording on a variety of recording media, as well as producing an image of high definition while avoiding bleeding of ink, and the like, and therefore is used as a generic image forming apparatus in a variety of fields.

In the case of ink ejection by an inkjet method, together with the occurrence of a main droplet, satellite droplets which are much smaller than the main droplet or a mist which separates from the main droplet and slows in velocity may be also produced. If evaporation of the functional material contained in the ink can be ignored, then the size of the mist particles is approximately 0.5 μm to 10 μm, and it is particularly difficult to suppress the occurrence of the mist particles of around 1 μm in size. The mist floats about inside the image forming apparatus, soils the interior of the image forming apparatus, and in particular, if the mist adheres to the nozzle plate (ejection face) of the ink ejection head, then it may give rise to ejection abnormalities. Furthermore, if the mist adheres to a detector, such as an encoder, then this gives rise to conveyance abnormalities of the recording medium and can lead to printing abnormalities caused by the conveyance abnormalities. These printing abnormalities have an adverse effect on image formation.

Japanese Patent Application Publication No. 2005-349799 discloses a method in which a discharge electrode for charging an ink mist and a collecting electrode for collecting the charged ink mist are provided, and ink mist generated during ejection is removed.

Japanese Patent Application Publication No. 2007-021840 discloses a method in which a conductive film covering the nozzle plate is applied with a voltage of a polarity opposite to a polarity of the charge carried by satellite droplets, and the satellite droplets are thereby attracted to the conductive film.

Here, the problems in the related art are described in detail with reference to FIGS. 10A to 11E.

FIGS. 10A to 10D are illustrative diagrams showing schematic views of states where a satellite droplet (an ink mist particle) 402 is produced when an ink droplet (main droplet) 400 is ejected from a nozzle 451, and the satellite droplet 402 then adheres to a nozzle face 450A.

FIG. 10A shows a state where a pillar-shaped ink droplet 400 has passed through the nozzle 451, and the leading end portion of the ink droplet 400 projects from the nozzle 451. Due to frictional electricity produced when the ink droplet 400 passes through the nozzle 451, the ink droplet 400 and the nozzle 451 (more specifically, a nozzle plate 451A) become charged. In a case where the material of the nozzle plate 451A is silicon, the ink droplet 400 is positively charged and the nozzle plate 451A is negatively charged.

FIG. 10B shows a state where the ink droplet 400 has been drawn out and severed (separated) from the ink 400A inside the nozzle 451. The ink forms the ink droplet 400 outside the nozzle 451. In the separated ink droplet 400, movement of the charged ions (denoted with “+” in the drawings) occurs.

FIG. 10C shows a state where a charged satellite droplet 402 has separated from the ink droplet 400 and the satellite droplet 402 is floating in the vicinity of the nozzle face 450A. The positively charged satellite droplet 402 is drawn toward the nozzle plate 451A (i.e., toward the nozzle face 450A), which is negatively charged, due to the action of the electrostatic force of attraction.

Thus, the satellite droplet 402 which is floating in the vicinity of the nozzle face 450A is drawn toward the nozzle face 450A by the electrostatic force and a part of the satellite droplet 402 adheres to the nozzle face 450A (FIG. 10D).

FIGS. 11A to 11E are illustrative diagrams showing schematic views of states where an ink mist particle adheres to the nozzle face 450A in a case where an electrode 460 is arranged on the nozzle face 450A (a case corresponding to Japanese Patent Application Publication No. 2007-021840). In FIGS. 11A to 11E, parts which are the same as or similar to those in FIGS. 10A to 10D are denoted with the same reference numerals and further explanation thereof is omitted here.

The ink droplet 400 has properties whereby the droplet is charged to the polarity opposite to the polarity of the electrode 460, and therefore if the electrode 460 is negatively charged, then the ink droplet 400 is positively charged (FIG. 11A). The satellite droplet 402 that has separated from the ink (main droplet) 400 is positively charged, similarly to the ink droplet 400 (FIGS. 11B to 11C).

The positively charged satellite droplet 402 is drawn toward the negatively charged electrode 460 due to the electrostatic force of attraction, and a part of the satellite droplet 402 adheres to the electrode 460 (FIG. 11D). If ink ejection is carried out continuously, then the satellite droplets 402 accumulate on the electrode 460 and overflow into the nozzle 451 (FIG. 11E). If a large volume of the satellite droplets 402 overflows into the nozzle 451, then all or a portion of the nozzle 451 is covered and there is a very high possibility of this giving rise to ejection abnormalities.

On the other hand, if the electrode 460 is positively charged, then the ink droplet 400 and the satellite droplets 402 are negatively charged. Then, similarly to the states shown in FIGS. 11D to 11E, due to the electrostatic force of attraction, a part of the satellite droplets 402 floating in the vicinity of the nozzle face 450A adheres to the electrode 460.

In the mist recovery by means of electrostatic attraction described in Japanese Patent Application Publication No. 2005-349799, it is difficult to collect the mist in a reliable manner. Moreover, in order to remove the mist in the vicinity of the nozzle plate, it is necessary to apply a strong electric field or a strong attraction force, and the strong electric field or attraction force may have adverse effects on the linearity of flight of the ejected ink droplets.

In the method disclosed in Japanese Patent Application Publication No. 2007-021840, satellite droplets adhere to the liquid ejection side surface of the inkjet head, and therefore periodic wiping of the surface is imperative. Moreover, it is not possible to use this method for ink that is liable to dry or solidify and adhere.

### SUMMARY OF THE INVENTION

The present invention has been contrived in view of these circumstances, an object thereof being to provide an image forming apparatus and a mist recovery method whereby mist-like droplets produced during ejection of liquid are prevented from adhering to the liquid ejection face, number of maintenance operations of the apparatus is reduced, and continuous operation over a long period of time becomes possible.

In order to attain the aforementioned object, the present invention is directed to an image forming apparatus, comprising: an inkjet head of an on-demand ejection type having a nozzle plate in which a nozzle electrode is arranged in a vicinity of a nozzle through which liquid is ejected; and a voltage application device which makes a polarity of the nozzle electrode one of positive and negative in accordance with a start of an ejection operation of the liquid, and then switches the polarity of the nozzle electrode to an opposite polarity to the one of positive and negative in accordance with a timing of ejecting the liquid through the nozzle.

In order to attain the aforementioned object, the present invention is also directed to a mist recovery method, comprising the steps of: making a polarity of a nozzle electrode one of positive and negative in accordance with a start of an ejection operation of liquid through a nozzle in an inkjet head of an on-demand ejection type, the nozzle electrode being arranged in a vicinity of the nozzle; and then switching the polarity of the nozzle electrode to an opposite polarity to the one of positive and negative in accordance with a timing of ejecting the liquid through the nozzle.

According to the present invention, by reversing the polarity of the nozzle electrode so as to assume the same polarity as the charge polarity of the ejected liquid in accordance with the ejection timing, it is possible to make an electrostatic force of repulsion act between the nozzle electrode and the mist-like droplet that has separated from the ejected droplet.

### BRIEF DESCRIPTION OF THE DRAWINGS

FIG. 1 is a general schematic drawing of an inkjet recording apparatus according to an embodiment of the present invention;

FIGS. 2A to 2C are plan view perspective diagrams showing embodiments of the inkjet head in FIG. 1;

FIG. 3 is a cross-sectional diagram showing the inner composition of an ink chamber unit;

FIG. 4 is a principal block diagram showing the system configuration of the inkjet recording apparatus in FIG. 1;

FIGS. 5A to 5E are illustrative diagrams showing schematic views of a mist recovery method according to an embodiment of the present invention;

FIG. 6 is a diagram illustrating the relationship between drive pulses and the reversal control of the nozzle electrode polarity;

FIG. 7 is a schematic plan diagram of an inkjet head showing a further embodiment of the composition of the nozzle electrodes shown in FIG. 3;

FIGS. 8A to 8D are schematic plan diagrams of inkjet heads showing other embodiments of the composition of the nozzle electrodes shown in FIG. 3;

FIG. 9 is a general schematic drawing showing a further mode of the inkjet recording apparatus shown in FIG. 1;

FIGS. 10A to 10D are diagrams for describing problems associated with the related art; and

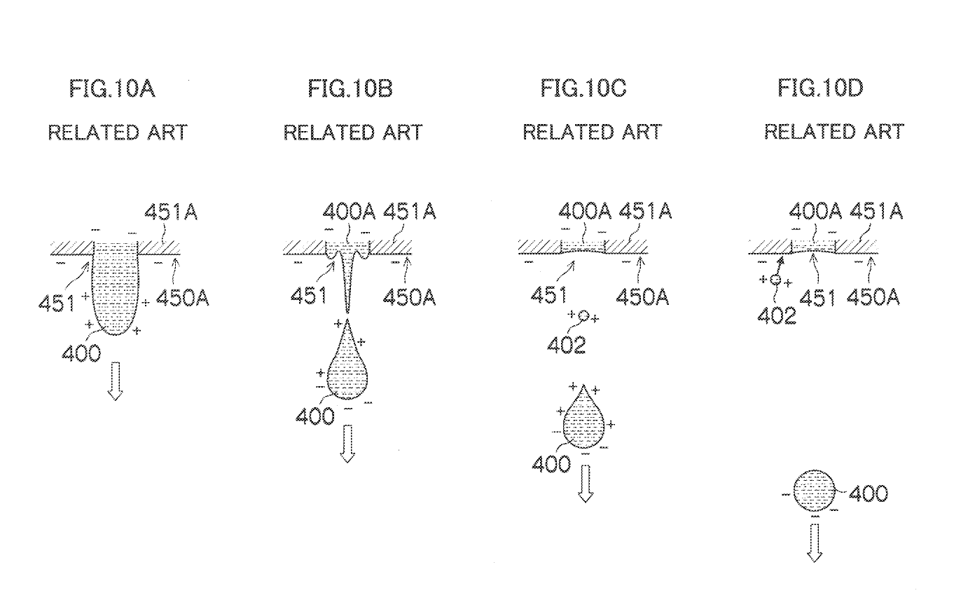

FIGS. 11A to 11E are diagrams for describing problems associated with the related art.

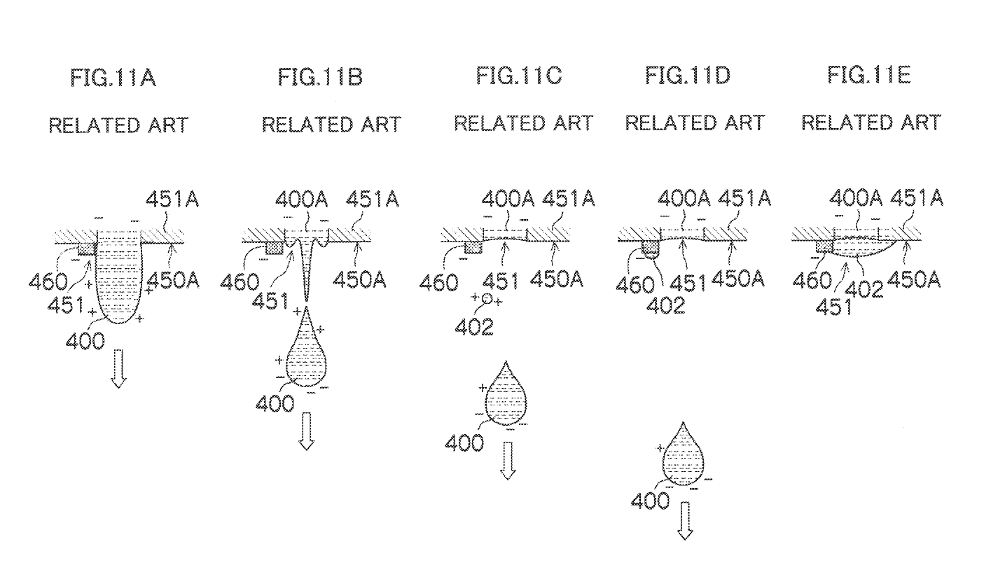

### DETAILED DESCRIPTION OF THE PREFERRED EMBODIMENTS

### Entire Configuration of Inkjet Recording Apparatus

First, an inkjet recording apparatus of an on-demand type will be described as an embodiment of an image forming apparatus according to the present invention.

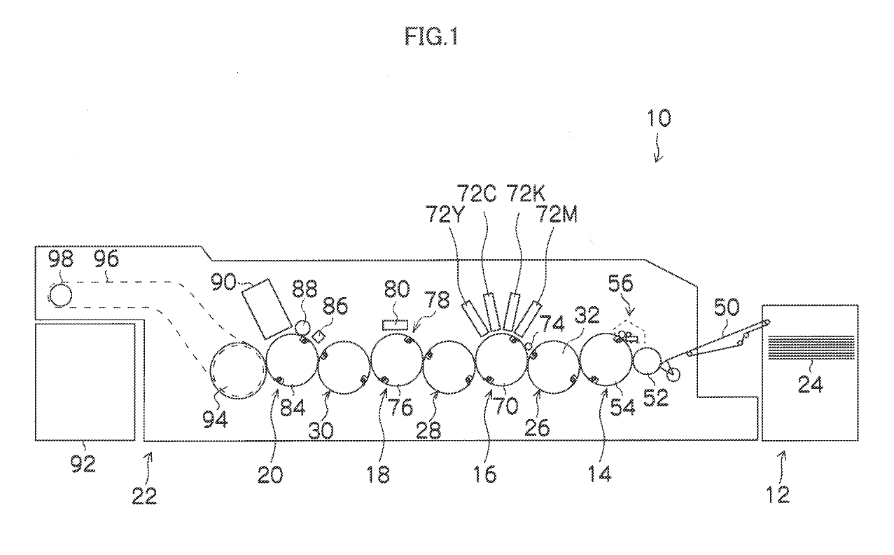

FIG. 1 is a structural diagram illustrating the entire configuration of an inkjet recording apparatus 10 according to an embodiment of the present invention. The inkjet recording apparatus 10 shown in the drawing is an recording apparatus in a two-liquid aggregating system of forming an image on a recording surface of a recording medium 24 by using ink (an aqueous ink) and a treatment liquid (aggregation treatment liquid). The inkjet recording apparatus 10 includes a paper feed unit 12, a treatment liquid application unit 14, an image formation unit 16, a drying unit 18, a fixing unit 20, and a discharge unit 22 as the main components. A recording medium 24 (paper sheets) is stacked in the paper feed unit 12, and the recording medium 24 is fed from the paper feed unit 12 to the treatment liquid application unit 14. A treatment liquid is applied to the recording surface in the treatment liquid application unit 14, and then a color ink is applied to the recording surface in the image formation unit 16. The image is fixed with the fixing unit 20 on the recording medium 24 onto which the ink has been applied, and then the recording medium is discharged with the discharge unit 22.

In the inkjet recording apparatus 10, intermediate conveyance units 26, 28 and 30 are provided between the units, and the recording medium 24 is transferred by these intermediate conveyance units 26, 28 and 30. Thus, a first intermediate conveyance unit 26 is provided between the treatment liquid application unit 14 and image formation unit 16, and the recording medium 24 is transferred from the treatment liquid application unit 14 to the image formation unit 16 by the first intermediate conveyance unit 26. Likewise, the second intermediate conveyance unit 28 is provided between the image formation unit 16 and the drying unit 18, and the recording medium 24 is transferred from the image formation unit 16 to the drying unit 18 by the second intermediate conveyance unit 28. Further, a third intermediate conveyance unit 30 is provided between the drying unit 18 and the fixing unit 20, and the recording medium 24 is transferred from the drying unit 18 to the fixing unit 20 by the third intermediate conveyance unit 30.

Each unit (paper feed unit 12, treatment liquid application unit 14, image formation unit 16, drying unit 18, fixing unit 20, and discharge unit 22) of the inkjet recording apparatus 10 will be described below in greater details.

### <Paper Feed Unit>

The paper feed unit 12 feeds the recording medium 24 to the image formation unit 16. A paper feed tray 50 is provided in the paper feed unit 12, and the recording medium 24 is fed, sheet by sheet, from the paper feed tray 50 to the treatment liquid application unit 14.

### <Treatment Liquid Application Unit>

The treatment liquid application unit 14 is a mechanism that applies a treatment liquid to the recording surface of the recording medium 24. The treatment liquid includes a coloring material aggregating agent that causes the aggregation of a coloring material (pigment) included in the ink applied in the image formation unit 16, and the separation of the coloring material and a solvent in the ink is enhanced when the treatment liquid is brought into contact with the ink.

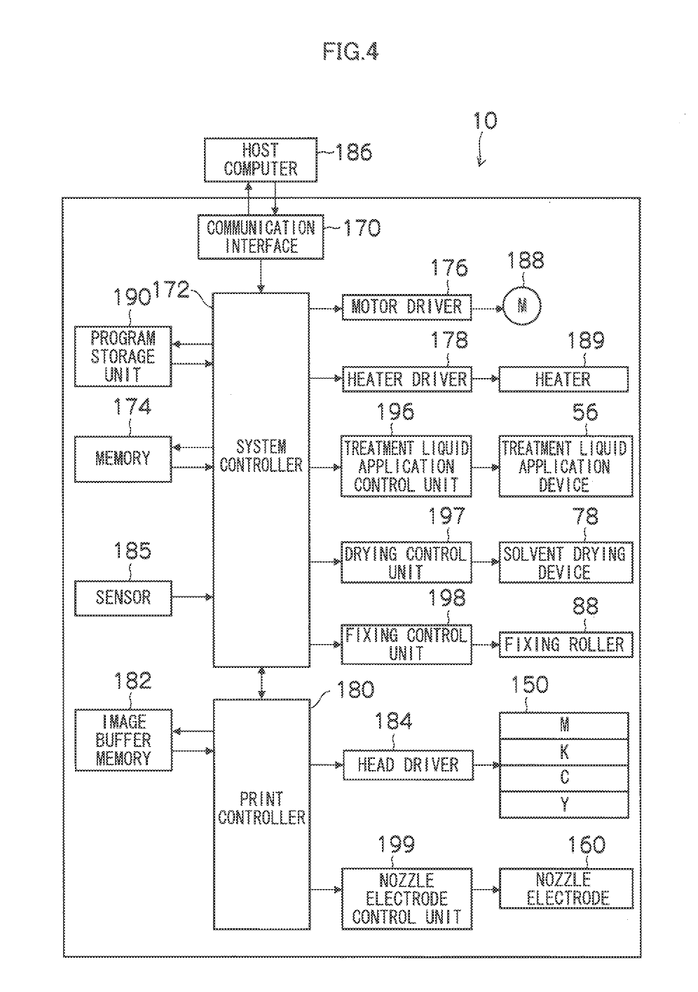

As shown in FIG. 1, the treatment liquid application unit 14 includes a paper transfer drum 52, a treatment liquid drum 54, and a treatment liquid application device 56. The paper transfer drum 52 is disposed between the paper feed tray 50 of the paper feed unit 12 and the treatment liquid drum 54. The rotation of the paper transfer drum 52 is driven and controlled by a below-described motor driver 176 (see FIG. 4). The recording medium 24 fed from the paper feed unit 12 is received by the paper transfer drum 52 and transferred to the treatment liquid drum 54. The below-described intermediate conveyance unit may be also provided instead of the paper transfer drum 52.

The treatment liquid drum 54 is a drum that holds and rotationally conveys the recording medium 24. The rotation of the treatment liquid drum 54 is driven and controlled by the below-described motor driver 176 (see FIG. 4). Further, the treatment liquid drum 54 is provided on the outer circumferential surface thereof with a hook-shaped holding device, by which the leading end of the recording medium 24 can be held. In a state in which the leading end of the recording medium 24 is held by the holding device, the treatment liquid drum 54 is rotated to rotationally convey the recording medium 24. In this case, the recording medium 24 is conveyed in a state where the recording surface thereof faces outward. The treatment liquid drum 54 may be provided with suction apertures on the outer circumferential surface thereof and connected to a suction device that performs suction from the suction apertures. As a result, the recording medium 24 can be held in a state of tight adherence to the outer circumferential surface of the treatment liquid drum 54.

The treatment liquid application device 56 is provided on the outside of the treatment liquid drum 54 opposite the outer circumferential surface thereof. The treatment liquid application device 56 applies the treatment liquid onto the recording surface of the recording medium 24. The treatment liquid application device 56 includes: a treatment liquid container, in which the treatment liquid to be applied is held; an anilox roller, a part of which is immersed in the treatment liquid held in the treatment liquid container; and a rubber roller, which is pressed against the anilox roller and the recording medium 24 that is held by the treatment liquid drum 54, so as to transfer the treatment liquid metered by the anilox roller 64 to the recording medium 24.

With the treatment liquid application device 56 of the above-described configuration, the treatment liquid is applied onto the recording medium 24, while being metered. In this case, it is preferred that the film thickness of the treatment liquid be sufficiently smaller than the diameter of ink droplets that are ejected from inkjet heads 72M, 72K, 72C and 72Y of the image formation unit 16. For example, when the ink droplet volume is 2 picoliters (pl), the average diameter of the droplet is 15.6 μm. In this case, when the film thickness of the treatment liquid is large, the ink dot will be suspended in the treatment liquid, without coming into contact with the surface of the recording medium 24. Accordingly, when the ink droplet volume is 2 μl, it is preferred that the film thickness of the treatment liquid be not more than 3 μm in order to obtain a landing dot diameter not less than 30 μm.

In the present embodiment, the application system using the roller is used to deposit the treatment liquid onto the recording surface of the recording medium 24; however, the present invention is not limited to this, and it is possible to employ a spraying method, an inkjet method, or other methods of various types.

In the present embodiment, the application system using the roller is used to deposit the treatment liquid onto the recording surface of the recording medium 24; however, the present invention is not limited to this, and it is possible to employ a spraying method, an inkjet method, or other methods of various types. Furthermore, in a printing method that fixes ink droplets having been deposited on a recording medium from the inkjet heads 72M, 72K, 72C and 72Y of the print unit 16, by applying energy to the ink through heating, pressing, irradiation of radiation, or the like, the treatment liquid deposition unit 14 is omitted.

### <Image Formation Unit>

The image formation unit 16 is a mechanism which prints an image corresponding to an input image by ejecting and depositing droplets of ink by an inkjet method, and the image formation unit 16 includes an image formation drum 70, a paper pressing roller 74 and the inkjet heads 72M, 72K, 72C and 72Y. The inkjet heads 72M, 72K, 72C and 72Y correspond to inks of four colors: magenta (M), black (K), cyan (C) and yellow (Y), and are disposed in the order of description from the upstream side in the rotation direction of the image formation drum 70.

The image formation drum 70 is a drum that holds the recording medium 24 on the outer circumferential surface thereof and rotationally conveys the recording medium 24. The rotation of the image formation drum 70 is driven and controlled by the below-described motor driver 176 (see FIG. 4).

Further, the image formation drum 70 is provided on the outer circumferential surface thereof with a hook-shaped holding device, by which the leading end of the recording medium 24 can be held. In a state in which the leading end of the recording medium 24 is held by the holding device, the image formation drum 70 is rotated to rotationally convey the recording medium 24. In this case, the recording medium 24 is conveyed in a state where the recording surface thereof faces outward, and inks are deposited on the recording surface by the inkjet heads 72M, 72K, 72C and 72Y.

The paper pressing roller 74 is a guide member for causing the recording medium 24 to tightly adhere to the outer circumferential surface of the image formation drum 70, and is arranged so as to face the outer circumferential surface of the image formation drum 70. More specifically, the paper pressing roller 74 is disposed to the downstream side of the position where transfer of the recording medium 24 is received, and to the upstream side from the inkjet heads 72M, 72K, 72C and 72Y, in terms of the direction of conveyance of the recording medium 24 (the direction of rotation of the image formation drum 70).

When the recording medium 24 that has been transferred onto the image formation drum 70 from the intermediate conveyance unit 26 is rotationally conveyed in a state where the leading end portion of the recording medium 24 is held by the holding device, the recording medium 24 is pressed by the paper pressing roller 74 to tightly adhere to the outer circumferential surface of the image formation drum 70. When the recording medium 24 has been made to tightly adhere to the outer circumferential surface of the image formation drum 70 in this way, the recording medium 24 is conveyed to a print region directly below the inkjet heads 72M, 72K, 72C and 72Y in a state where the recording medium 24 does not float up at all from the outer circumferential surface of the image formation drum 70.

The inkjet heads 72M, 72K, 72C and 72Y are recording heads (inkjet heads) of the inkjet system of the full line type that have a length corresponding to the maximum width of the image formation region in the recording medium 24. A nozzle row is formed on the ink ejection surface of the inkjet head. The nozzle row has a plurality of nozzles arranged therein for discharging ink over the entire width of the image recording region. Each of the inkjet heads 72M, 72K, 72C and 72Y is fixedly disposed so as to extend in the direction perpendicular to the conveyance direction (rotation direction of the image formation drum 70) of the recording medium 24.

Furthermore, each of the inkjet heads 72M, 72K, 72C and 72Y is disposed at an inclination with respect to the horizontal, in such a manner that each of the nozzle surfaces of the inkjet heads 72M, 72K, 72C and 72Y is substantially parallel to the recording surface of the recording medium 24 held on the outer circumferential surface of the image formation drum 70.

Droplets of corresponding colored inks are ejected from the inkjet heads 72M, 72K, 72C and 72Y having the above-described configuration toward the recording surface of the recording medium 24 held on the outer circumferential surface of the image formation drum 70. As a result, the ink comes into contact with the treatment liquid that has been heretofore applied on the recording surface by the treatment liquid application unit 14, the coloring material (pigment) dispersed in the ink is aggregated, and a coloring material aggregate is formed. Therefore, the coloring material flow on the recording medium 24 is prevented and an image is formed on the recording surface of the recording medium 24. In this case, because the image formation drum 70 of the image formation unit 16 is structurally separated from the treatment liquid drum 54 of the treatment liquid application unit 14, the treatment liquid does not adhere to the inkjet heads 72M, 72K, 72C and 72Y, and the number of factors preventing the ejection of ink can be reduced.

In the present embodiment, the CMYK standard color (four colors) configuration is described, but combinations of ink colors and numbers of colors are not limited to that of the present embodiment, and if necessary, light inks, dark inks, and special color inks may be added. For example, a configuration is possible in which inkjet heads are added that eject light inks such as light cyan and light magenta. The arrangement order of color heads is also not limited.

### <Drying Unit>

The drying unit 18 dries water included in the solvent separated by the coloring material aggregation action. As shown in FIG. 1, the drying unit includes a drying drum 76 and a solvent dryer 78.

The drying drum 76 is a drum that holds the recording medium 24 on the outer circumferential surface thereof and rotationally conveys the recording medium 24. The rotation of the drying drum 76 is driven and controlled by the below-described motor driver 176 (see FIG. 4). Further, the drying drum 76 is provided on the outer circumferential surface thereof with a hook-shaped holding device, by which the leading end of the recording medium 24 can be held. In a state in which the leading end of the recording medium 24 is held by the holding device, the drying drum 76 is rotated to rotationally convey the recording medium. In this case, the recording medium 24 is conveyed in a state where the recording surface thereof faces outward. The drying treatment is carried out by the solvent dryer 78 with respect to the recording surface of the recording medium 24. The drying drum 76 may be provided with suction apertures on the outer circumferential surface thereof and connected to a suction device that performs suction from the suction apertures. As a result, the recording medium 24 can be held in a state of tight adherence to the outer circumferential surface of the drying drum 76.

The solvent dryer 78 is disposed in a position facing the outer circumferential surface of the drying drum 76, and includes a halogen heater 80. The halogen heater 80 is controlled to blow warm air at a prescribed temperature (for example, 50° C. to 70° C.) at a constant blowing rate (for example, 12 m³/min) toward the recording medium 24.

With the solvent dryer 78 of the above-described configuration, water included in the ink solvent on the recording surface of the recording medium 24 held by the drying drum 76 is evaporated, and drying treatment is performed. In this case, because the drying drum 76 of the drying unit 18 is structurally separated from the image formation drum 70 of the image formation unit 16, the number of ink non-ejection events caused by drying of the head meniscus portion by thermal drying can be reduced in the inkjet heads 72M, 72K, 72C and 72Y. Further, there is a degree of freedom in setting the temperature of the drying unit 18, and the optimum drying temperature can be set.

It is desirable that the curvature of the drying drum 76 is in the range of not less than 0.002 (l/mm) and not more than 0.0033 (l/mm). If the curvature of the drying drum 76 is less than 0.002 (l/mm), then even if the recording medium 24 is made to curve, an insufficient effect in correcting cockling of the recording medium 24 is obtained, and if the curvature exceeds 0.0033 (l/mm), then the recording medium 24 is curved more than necessary and does not return to its original shape, but rather is output to the stack in a curved state.

Furthermore, it is desirable that the surface temperature of the drying drum 76 is set to 50° C. or above. By heating from the rear surface of the recording medium 24, drying is promoted and breaking of the image during fixing can be prevented. In this case, more beneficial effects are obtained if a device for causing the recording medium 24 to tightly adhere to the outer circumferential surface of the drying drum 76 is provided. As a device for causing the recording medium 24 to tightly adhere in this way, it is possible to employ various methods, such as vacuum suction, electrostatic attraction, or the like.

There are no particular restrictions on the upper limit of the surface temperature of the drying drum 76, but from the viewpoint of the safety of maintenance operations such as cleaning the ink adhering to the surface of the drying drum 76 (namely, preventing burns due to high temperature), desirably, the surface temperature of the drying drum 76 is not higher than 75° C. (and more desirably, not higher than 60° C.).

By holding the recording medium 24 in such a manner that the recording surface thereof is facing outward on the outer circumferential surface of the drying drum 76 having this composition (in other words, in a state where the recording surface of the recording medium 24 is curved in a convex shape), and drying while conveying the recording medium in rotation, it is possible to prevent the occurrence of wrinkles or floating up of the recording medium 24, and therefore drying non-uniformities caused by these phenomena can be prevented reliably.

### <Fixing Unit>

The fixing unit 20 includes a fixing drum 84, a halogen heater 86, a fixing roller 88, and an inline sensor 90. The halogen heater 86, the fixing roller 88, and the inline sensor 90 are arranged in positions opposite the outer circumferential surface of the fixing drum 84 in this order from the upstream side in the rotation direction (counterclockwise direction in FIG. 1) of the fixing drum 84.

The fixing drum 84 a drum that holds the recording medium 24 on the outer circumferential surface thereof and rotationally conveys the recording medium 24. The rotation of the fixing drum 84 is driven and controlled by the below-described motor driver 176 (see FIG. 4). The fixing drum 84 has a hook-shaped holding device, and the leading end of the recording medium 24 can be held by this holding device. The recording medium 24 is rotationally conveyed by rotating the fixing drum 84 in a state in which the leading end of the recording medium 24 is held by the holding device. In this case, the recording medium 24 is conveyed in a state where the recording surface thereof faces outward, and the preheating by the halogen heater 86, the fixing treatment by the fixing roller 88 and the inspection by the inline sensor 90 are performed with respect to the recording surface. The fixing drum 84 may be provided with suction apertures on the outer circumferential surface thereof and connected to a suction device that performs suction from the suction apertures. As a result, the recording medium 24 can be held in a state of tight adherence to the outer circumferential surface of the fixing drum 84.

The halogen heater 86 is controlled to a prescribed temperature (for example, 180° C.), by which the preheating is performed with respect to the recording medium 24.

The fixing roller 88 is a roller member which applies heat and pressure to the dried ink to melt and fix the self-dispersible polymer particles in the ink so as to transform the ink into the film. More specifically, the fixing roller 88 is arranged so as to be pressed against the fixing drum 84, and a nip roller is configured between the fixing roller 88 and the fixing drum 84. As a result, the recording medium 24 is squeezed between the fixing roller 88 and the fixing drum 84, nipped under a prescribed nip pressure (for example, 0.15 MPa), and subjected to fixing treatment.

Further, the fixing roller 88 is configured by a heating roller in which a halogen lamp is incorporated in a metal pipe, for example made from aluminum, having good thermal conductivity and the rollers are controlled to a prescribed temperature (for example 60° C. to 80° C.). Where the recording medium 24 is heated with the heating roller, thermal energy not lower than a Tg temperature (glass transition temperature) of a latex included in the ink is applied and latex particles are melted. As a result, fixing is performed by penetration into the projections-recessions of the recording medium 24, the projections-recessions of the image surface are leveled out, and gloss is obtained.

The fixing unit 20 is provided with the single fixing roller 88 in the above-described embodiment; however, it is possible that a plurality of fixing rollers 88 depending on the thickness of image layer and Tg characteristic of latex particles. Furthermore, the surface of the fixing drum 84 may be controlled to a prescribed temperature (for example 60° C.).

On the other hand, the inline sensor 90 is a measuring device which measures the check pattern, moisture amount, surface temperature, gloss, and the like of the image fixed to the recording medium 24. A CCD sensor or the like can be used for the inline sensor 90.

With the fixing unit 20 of the above-described configuration, the latex particles located within a thin image layer formed in the drying unit 18 are melted by application of heat and pressure by the fixing roller 88. Thus, the latex particles can be reliably fixed to the recording medium 24. In addition, with the fixing unit 20, the fixing drum 84 is structurally separated from other drums. Therefore, the temperature of the fixing unit 20 can be freely set separately from the image formation unit 16 and the drying unit 18.

In particular, similarly to the drying drum 76 described above, the fixing drum 84 used in the present embodiment is constituted of a rotating conveyance body having a prescribed curvature and a surface temperature set to a prescribed temperature, and desirably, the curvature of the fixing drum 84 is in a range of not less than 0.002 (l/mm) and not more than 0.0033 (l/mm) or lower. If the curvature of the fixing drum 84 is less than 0.002 (l/mm), then even if the recording medium 24 is made to curve, an insufficient effect in correcting cockling of the medium is obtained, and if the curvature exceeds 0.0033 (l/mm), then the recording medium 24 is curved more than necessary and does not return to its original shape, but rather is output to the stack in a curved state.

It is desirable that the surface temperature of the fixing drum 84 is set to 50° C. or above. Drying is promoted by heating the recording medium 24 held on the outer circumferential surface of the fixing drum 84 from the rear surface, and therefore breaking of the image during fixing can be prevented, and furthermore, the strength of the image can be increased by the effects of the increased temperature of the image.

There are no particular restrictions on the upper limit of the surface temperature of the fixing drum 84, but desirably, it is set to 75° C. or lower (and more desirably, 60° C. or lower), from the viewpoint of maintenance characteristics.

Moreover, it is desirable that the fixing roller 88 used in the present embodiment has a surface hardness of not higher than 71°. By making the surface of the fixing roller 88, which is a heating and pressing member, softer, it is possible to expect a beneficial effect in the fixing roller following the indentations which occur in the recording medium 24 as a result of cockling, then it is possible to prevent the occurrence of fixing non-uniformities.

Furthermore, it is desirable to achieve a state where the moisture in the image has been evaporated off and the high-boiling-point organic solvent has been concentrated to a suitable concentration in the image (in other words, a state where the high-boiling-point organic solvent in the image remains at a rate of 4% or more of the ink droplet ejection volume), since the image deforms more readily with respect to the surface of the fixing roller (heating and pressing member) 88 during fixing, while having sufficient strength to avoid breaking of the image. Moreover, if a binder component is contained in the image, then it is desirable to preheat the image, so that the image can be expected to similarly follow the surface of the fixing roller 88, and fixing non-uniformities can be prevented yet more effectively.

Here, the “state where the high-boiling-point organic solvent in the image remains at a rate of 4% or more of the ink droplet ejection volume” means that the ratio of the remaining amount of high-boiling-point organic solvent in the image present on the surface of the recording medium with respect to the ink droplet ejection volume at the time of the fixing process is 4% or above.

By holding the recording medium 24 with the recording surface thereof facing outward on the outer circumferential surface of the fixing drum 84 having this composition (in other words, in a state where the recording surface of the recording medium 24 is curved in a convex shape), and heating and pressing to fix the image while conveying the recording medium in rotation, then even in a state where the moisture is not completely dried off and some degree of cockling is liable to occur, this cockling can be rectified.

Furthermore, since fixing can be carried out by the fixing roller 88 in a state where the surface of the recording medium 24 is pulled and stretched against the force that seeks to create indentations in the surface (recording surface) of the recording medium 24 due to the swelling of the pulp fibers, and hence the indentations caused by cockling have been alleviated and flattened, then it is possible to prevent the occurrence of fixing non-uniformities caused by cockling.

### <Discharge Unit>

As shown in FIG. 1, the discharge unit 22 is provided after the fixing unit 20. The discharge unit 22 includes a discharge tray 92, and a transfer body 94, a conveying belt 96, and a tension roller 98 are provided between the discharge tray 92 and the fixing drum 84 of the fixing unit 20 so as to face the discharge tray 92 and the fixing drum 84. The recording medium 24 is fed by the transfer body 94 onto the conveying belt 96 and discharged onto the discharge tray 92.

### <Intermediate Conveyance Unit>

The structure of the first intermediate conveyance unit 26 will be described below. The second intermediate conveyance unit 28 and the third intermediate conveyance unit 30 are configured identically to the first intermediate conveyance unit 26 and the explanation thereof will be omitted.

The first intermediate conveyance unit 26 is provided with an intermediate conveyance body 32, which is a drum for receiving the recording medium 24 from a drum of a previous stage, rotationally conveying the recording medium 24, and transferring it to a drum of the subsequent stage, and is mounted to be capable of rotating freely. The intermediate conveyance body 32 is rotated by a motor 188 (not shown in FIG. 1 and shown in FIG. 4), and the rotation thereof is driven and controlled by the below-described motor driver 176 (see FIG. 4). Further, the intermediate conveyance body 32 is provided on the outer circumferential surface thereof with a hook-shaped holding device, by which the leading end of the recording medium 24 can be held. In a state in which the leading end of the recording medium 24 is held by the holding device, the intermediate conveyance body 32 is rotated to rotationally convey the recording medium 24. In this case, the recording medium 24 is conveyed in a state where the recording surface thereof faces inward, whereas the non-recording surface thereof faces outward.

The recording medium 24 conveyed by the first intermediate conveyance unit 26 is transferred to a drum of the subsequent stage (that is, the image formation drum 70). In this case, the transfer of the recording medium 24 is performed by synchronizing the holding device of the intermediate conveyance unit 26 and the holding device (the gripper 102) of the image formation unit 16. The transferred recording medium 24 is held by the image formation drum 70 and rotationally conveyed.

### <Structure of Ink Heads>

Next, the structure of the inkjet heads is described. The inkjet heads 72M, 72K, 72C and 72Y for the respective colored inks have the same structure, and a reference numeral 150 is hereinafter designated to any of the inkjet heads (hereinafter also referred to simply as the heads).

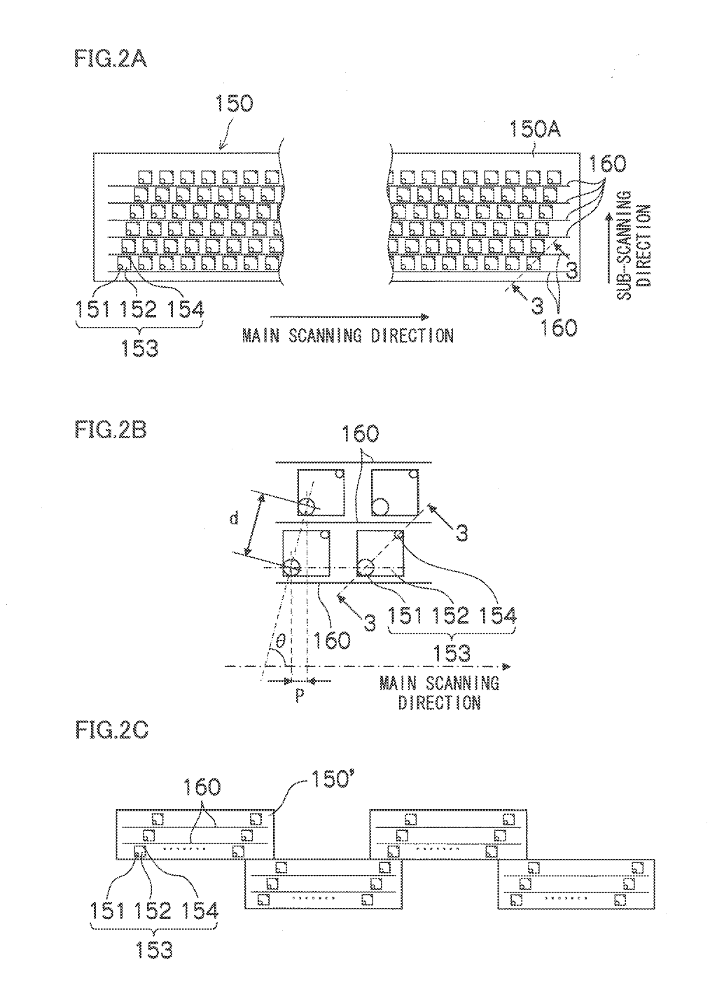

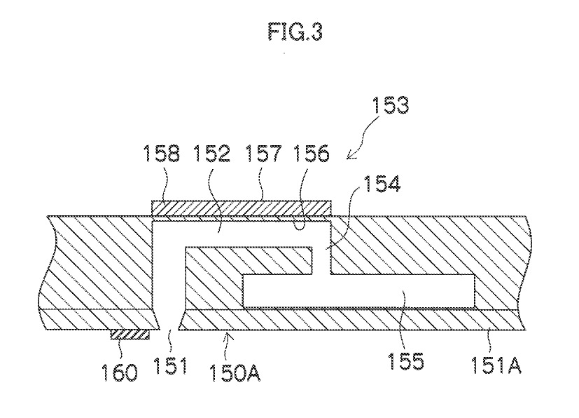

FIG. 2A is a perspective plan view showing an embodiment of the configuration of the head 150, FIG. 2B is an enlarged view of a portion thereof, and FIG. 2C is a perspective plan view showing another embodiment of the configuration of the head 150. FIG. 3 is a cross-sectional view taken along the line 3-3 in FIGS. 2A and 2B, showing the inner structure of an ink chamber unit in the head 150.

The nozzle pitch in the head 150 should be minimized in order to maximize the density of the dots printed on the surface of the recording medium 24. As shown in FIGS. 2A and 2B, the head 150 according to the present embodiment has a structure in which a plurality of ink chamber units (i.e., droplet ejection units serving as recording units) 153, each having a nozzle 151 forming an ink ejection aperture formed in a nozzle plate 151A (shown in FIG. 3), a pressure chamber 152 corresponding to the nozzle 151, and the like, are disposed two-dimensionally in the form of a staggered matrix, and hence the effective nozzle interval (the projected nozzle pitch) as projected in the lengthwise direction of the head 150 (the main scanning direction: the direction perpendicular to the conveyance direction of the recording medium 24) is reduced and high nozzle density is achieved.

The mode of forming one or more nozzle rows through a length corresponding to the entire width of the recording medium 24 in the main scanning direction substantially perpendicular to the conveyance direction of the recording medium 24 (the sub-scanning direction) is not limited to the embodiment described above. For example, instead of the configuration in FIG. 2A, as shown in FIG. 2C, a line head having nozzle rows of a length corresponding to the entire width of the recording medium 24 can be formed by arranging and combining, in a staggered matrix, short head blocks 150′ having a plurality of nozzles 151 arrayed in a two-dimensional fashion. Furthermore, although not shown in the drawings, it is also possible to compose a line head by arranging short heads in one row.

The head 150 employed in the present embodiment has nozzle electrodes 160 formed on a nozzle face (ink ejection face) 150A of the nozzle plate 151A (shown in FIG. 3) in which the nozzles 151 are arranged. Each of the nozzle electrodes 160 is arranged through the length of each of the nozzle rows in the main scanning direction, on the upstream side of the nozzle row aligned in the main scanning direction, in terms of the recording medium conveyance direction.

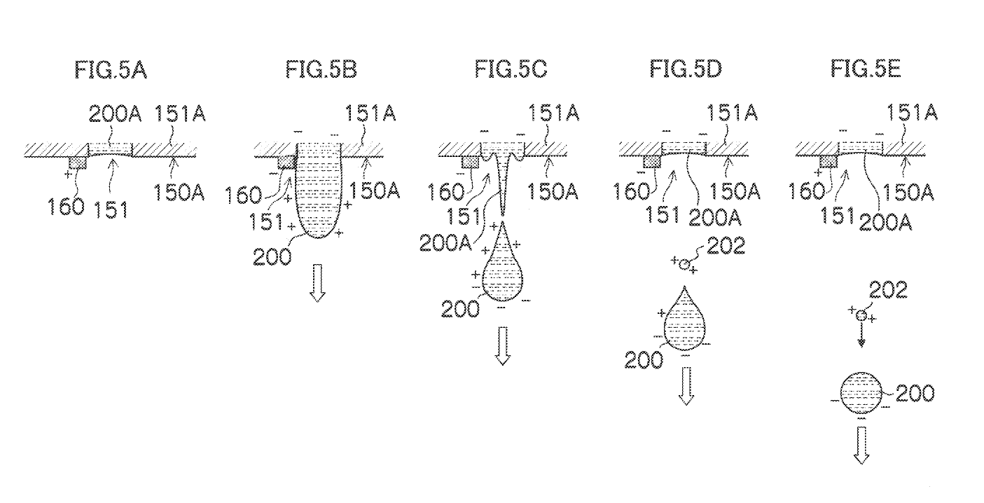

When the nozzle electrode 160 is applied with a voltage of the polarity opposite to the charge polarity of a satellite droplet 202 (shown in FIGS. 5D and 5E; corresponding to mist-like droplets) floating in the vicinity of the nozzle face 150A, in accordance with the timing of ink ejection, then an electrostatic force of repulsion acts between the nozzle electrode 160 and the satellite droplet 202, and the satellite droplet 202 is driven in a direction away from the nozzle face 150A, so that adherence to the nozzle face 150A of the satellite droplets stagnating in the vicinity of the nozzle face 150A is prevented. It is desirable to use a metal material having high electrical conductivity, such as gold or platinum, for the nozzle electrodes 160.

The nozzle electrodes 160 are covered with a protective film (not shown) which has electrical insulating properties. The protective film may be patterned so as to correspond to the nozzle electrodes 160 or may be formed over the entire surface of the nozzle face 150A apart from the opening sections of the nozzles 151.

For the nozzle plate 151A, it is desirable to employ a silicon or metal material which can be processed readily with high accuracy. If a metal material is used for the nozzle plate 151A, an insulating film may be inserted between the nozzle plate 151A and the nozzle electrodes 160.

Although FIGS. 2A to 2C show a mode where the nozzle electrodes 160 are arranged on the upstream sides of the nozzles 151 in terms of the conveyance direction of the recording medium, it is also possible to arrange the nozzle electrodes 160 on the downstream sides of the nozzles 151 in terms of the conveyance direction of the recording medium, or to arrange the nozzle electrodes 160 on both the upstream sides and the downstream sides of the nozzles 151 in terms of the conveyance direction of the recording medium. If the nozzle electrodes 160 are arranged in areas in the vicinity of the opening sections of the nozzles 151, then it is possible to prevent the adherence of satellite droplets to the periphery of the opening sections of the nozzles 151 even more effectively.

The planar shape of the pressure chamber 152 provided for each nozzle 151 is substantially a square, and the nozzle 151 and an ink supply port 154 are disposed in both corners on a diagonal line of the square. The shape of the pressure chamber 152 is not limited to that of the present embodiment, and a variety of planar shapes, for example, a polygon such as a rectangle (rhomb, rectangle, etc.), a pentagon and a heptagon, a circle, and an ellipse can be employed.

Each pressure chamber 152 is connected to a common channel 155 through the supply port 154. The common channel 155 is connected to an ink tank (not shown), which is a base tank for supplying ink, and the ink supplied from the ink tank is delivered through the common flow channel 155 to the pressure chambers 152.

A piezoelectric element 158 provided with an individual electrode 157 is bonded to a diaphragm 156, which forms a face (the upper face in FIG. 3) of the pressure chamber 152 and also serves as a common electrode. When a drive voltage is applied to the individual electrode 157, the piezoelectric element 158 is deformed, the volume of the pressure chamber 152 is thereby changed, and the ink is ejected from the nozzle 151 by the variation in pressure that follows the variation in volume. When the piezoelectric element 158 returns to the original state after the ink has been ejected, the pressure chamber 152 is refilled with new ink from the common channel 155 through the supply port 154.

The present embodiment applies the piezoelectric elements 158 as ejection power generation devices to eject the ink from the nozzles 151 arranged in the head 150; however, instead, a thermal system that has heaters within the pressure chambers 152 to eject the ink using the pressure resulting from film boiling by the heat of the heaters can be applied.

As shown in FIG. 2B, the high-density nozzle head according to the present embodiment is achieved by arranging the plurality of ink chamber units 153 having the above-described structure in a lattice fashion based on a fixed arrangement pattern, in a row direction which coincides with the main scanning direction, and a column direction which is inclined at a fixed angle of θ with respect to the main scanning direction, rather than being perpendicular to the main scanning direction.

More specifically, by adopting a structure in which the ink chamber units 153 are arranged at a uniform pitch d in line with a direction forming the angle of θ with respect to the main scanning direction, the pitch P of the nozzles projected so as to align in the main scanning direction is d×cos θ, and hence the nozzles 151 can be regarded to be equivalent to those arranged linearly at a fixed pitch P along the main scanning direction. Such configuration results in a nozzle structure in which the nozzle row projected in the main scanning direction has a high nozzle density of up to 2,400 nozzles per inch.

When implementing the present invention, the arrangement structure of the nozzles is not limited to the embodiments shown in the drawings, and it is also possible to apply various other types of nozzle arrangements, such as an arrangement structure having one nozzle row in the sub-scanning direction.

Furthermore, the scope of application of the present invention is not limited to a printing system based on the line type of head, and it is also possible to adopt a serial system where a short head that is shorter than the breadthways dimension of the recording medium 24 is moved in the breadthways direction (main scanning direction) of the recording medium 24, thereby performing printing in the breadthways direction, and when one printing action in the breadthways direction has been completed, the recording medium 24 is moved through a prescribed amount in the sub-scanning direction perpendicular to the breadthways direction, printing in the breadthways direction of the recording medium 24 is carried out in the next printing region, and by repeating this sequence, printing is performed over the whole surface of the printing region of the recording medium 24.

### Description of Control System

FIG. 4 is a block diagram of the main portion of a system configuration of the inkjet recording apparatus 10. The inkjet recording apparatus 10 includes a communication interface 170, a system controller 172, a memory 174, the motor driver 176, a heater driver 178, a printing control unit 180, an image buffer memory 182, a head driver 184, a sensor 185, a program storage unit 190, a treatment liquid application control unit 196, a drying control unit 197, a fixing control unit 198, and a nozzle electrode control unit 199.

The communication interface 170 is an interface unit that receives image data sent from a host computer 186. A serial interface such as USB (Universal Serial Bus), IEEE 1394, Ethernet, and a wireless network, or a parallel interface such as Centronix can be applied as the communication interface 170. A buffer memory (not shown) may be installed in the part of the interface to increase the communication speed. The image data sent from the host computer 186 are introduced into the inkjet recording apparatus 10 through the communication interface 170 and temporarily stored in the memory 174.

The memory 174 is a storage device that temporarily stores the images inputted through the communication interface 170 and reads/writes the data via the system controller 172. The memory 174 is not limited to a memory composed of semiconductor elements and may use a magnetic medium such as a hard disk.

The system controller 172 includes a central processing unit (CPU) and a peripheral circuitry thereof, functions as a control device that controls the entire inkjet recording apparatus 10 according to a predetermined program, and also functions as an operational unit that performs various computations. Thus, the system controller 172 controls various units such as the communication interface 170, the memory 174, the motor driver 176, the heater driver 178, the treatment liquid application control unit 196, the drying control unit 197 and the fixing control unit 198, performs communication control with the host computer 180, performs read/write control of the memory 174, and also generates control signals for controlling the various units.

Programs that are executed by the CPU of the system controller 172 and various data necessary for performing the control are stored in the memory 174. The memory 174 may be a read-only storage device or may be a writable storage device such as EEPROM. The memory 174 can be also used as a region for temporary storing image data, a program expansion region, and a computational operation region of the CPU.

Various control programs are stored in the program storage unit 190, and a control program is read out and executed in accordance with commands from the system controller 172. The program storage unit 190 may use a semiconductor memory, such as a ROM, EEPROM, or a magnetic disk, or the like. The program storage unit 190 may be provided with an external interface, and a memory card or PC card may also be used. Naturally, a plurality of these storage media may also be provided. The program storage unit 190 may also be combined with a storage device for storing operational parameters, and the like (not shown).

The motor driver 176 drives a motor 188 in accordance with commands from the system controller 172. In FIG. 4, the plurality of motors disposed in the respective sections of the inkjet recording apparatus 10 are represented by the reference numeral 188. For example, the motor 188 shown in FIG. 4 includes the motors that drive the paper transfer drum 52, the treatment liquid drum 54, the image formation drum 70, the drying drum 76, the fixing drum 84 and the transfer body 94 shown in FIG. 1, and the motors that drive the intermediate conveyance bodies 32 in the first, second and third intermediate conveyance units 26, 28 and 30.

The heater driver 178 is a driver that drives the heater 189 in accordance with commands from the system controller 172. In FIG. 4, the plurality of heaters disposed in the inkjet recording apparatus 10 are represented by the reference numeral 189. For example, the heater 189 shown in FIG. 4 includes the halogen heaters 80 in the solvent dryer 78 arranged in the drying unit 18 shown in FIG. 1, the halogen heaters in the drying units 38 arranged in the intermediate conveyance bodies 32, and the heaters that heat the surfaces of the drying drum 76 and the fixing drum 84 shown in FIG. 1.

The treatment liquid application control unit 196, the drying control unit 197 and the fixing control unit 198 control the operations of the treatment liquid application device 56, the solvent dryer 78 and the fixing roller 88, respectively, in accordance with commands from the system controller 172.

The printing control unit 180 has a signal processing function for performing a variety of processing and correction operations for generating signals for print control from the image data within the memory 174 according to control of the system controller 172, and supplies the generated printing data (dot data) to the head driver 184. The required signal processing is implemented in the printing control unit 180, and the ejection amount and ejection timing of droplets in the heads 150 are controlled through the head driver 184 based on the image data. As a result, the desired dot size and dot arrangement are realized.

The printing control unit 180 is provided with the image buffer memory 182, and data such as image data or parameters are temporarily stored in the image buffer memory 182 during image data processing in the printing control unit 180. A mode is also possible in which the printing control unit 180 and the system controller 172 are integrated and configured by one processor.

The head driver 184 generates drive signals for driving the piezoelectric elements 158 of the heads 150, on the basis of the dot data supplied from the print controller 180, and drives the piezoelectric elements 158 by applying the generated drive signals to the piezoelectric elements 158. A feedback control system for maintaining constant drive conditions in the recording heads 150 may be included in the head driver 184 shown in FIG. 4.

The sensor 185 represents the sensors disposed in the respective sections of the inkjet recording apparatus 10. For example, the sensor 185 includes the inline sensor 90 shown in FIG. 1, temperature sensors, position determination sensors, pressure sensors, and a linear encoder arranged in the conveyance unit. The output signals of the sensor 185 are sent to the system controller 172, and the system controller 172 controls the respective sections of the inkjet recording apparatus 10 by sending the command signals to the respective sections in accordance with the output signals of the sensor 185.

The nozzle electrode control unit 199 controls switching between charging and non-charging of the nozzle electrodes 160, as well as controlling the polarity switching of the nozzle electrodes 160. The print controller 180 sends drive signals to the heads 150 through the head driver 184 and also sends command signals corresponding to the drive signals to the nozzle electrode control unit 199, which switches the charging and non-charging of the nozzle electrodes 160 and switches the charge polarity at a prescribed timing, in accordance with the command signals.

### Description of Control of Nozzle Electrodes

Next, the control of the nozzle electrodes 160 according to the ink mist recovery method in the present embodiment will be described in detail.

FIGS. 5A to 5E are illustrative diagrams showing schematic views of the control of the nozzle electrode 160, and the behavior of an ink droplet (main droplet) 200 and the satellite droplet 202.

FIG. 5A shows an ejection standby state where a drive signal for ink ejection has not been applied to the piezoelectric element 158 (see FIG. 3). As shown in FIG. 5A, the nozzle electrode 160 in the ejection standby state is applied with the positive voltage.

FIG. 5B shows a state during an ejection operation where a drive signal is applied (a state where the leading end portion of the ink droplet 200 in the pillar-form is projected externally from the nozzle 151). As shown in FIG. 5B, the polarity of the nozzle electrode 160 has been switched from positive to negative upon the start of the ejection operation. The ink droplet 200 that has passed through the nozzle 151 in this state is charged to the positive polarity (the opposite to the polarity of the nozzle electrode 160) by frictional charging. A “+” sign in FIG. 5B represents a positively charged ion and a “−” sign represents a negatively charged ion in the ink.

Here, since the nozzle electrode 160 is applied with the negative voltage, then the positively charged ions (+) in the ink droplet 200 before severing are drawn toward the nozzle electrode 160 side, and the negatively charged ions (−) move in the opposite direction to the nozzle electrode 160 due to the repulsion with respect to the positively charged ions (+).

FIG. 5C shows a state where the ink droplet 200 that has projected to the exterior of the nozzle 151 is severed from the ink 200A inside the nozzle 151, forming the separated main droplet. Since the nozzle electrode 160 is applied with the negative voltage when the main droplet 200 is severed, then the positively charged ions (+) are drawn to the portion of the severed main droplet 200 that is near the nozzle electrode 160, and the negatively charged ions (−) collect in the portion that is distant from the nozzle electrode 160.

FIG. 5D shows a state where the satellite droplet 202 has broken off from the main droplet 200. Since the satellite droplet 202 breaks off from the portion of the main droplet 200 near the nozzle electrode 160 (the portion where the positively charged ions have collected), then the satellite droplet 202 is positively charged. In this case, if the nozzle electrode 160 is still applied with the negative voltage, then an electrostatic force of attraction acts and the nozzle electrode 160 would attract the positively charged satellite droplet 202. Here, if the nozzle electrode 160 is switched to be applied with the positive voltage (the same polarity as the charge polarity of the satellite droplet 202), then an electrostatic force of repulsion acts between the nozzle electrode 160 and the satellite droplet 202, and the satellite droplet 202 is driven in the direction away from the nozzle face 150A (nozzle plate 151A) (see FIG. 5E).

On the other hand, the breaking off of the positively charged satellite droplet 202 from the main droplet 200 effectively results in the main droplet 200 assuming a negatively charged state. Here, the main droplet 200 has sufficient mass and velocity to be relatively unaffected even if the nozzle electrode 160 is applied with the positive voltage, and therefore is not attracted toward the nozzle electrode 160. Furthermore, an electrostatic force of attraction acts between the positively charged satellite droplet 202 and the negatively charged main droplet 200, thereby promoting the unification of the satellite droplet 202 with the main droplet 200.

More specifically, from the viewpoint of attracting the satellite droplet 202, it is desirable that the main droplet 200 is charged to the opposite polarity to the satellite droplet 202.

Furthermore, it is also possible to adopt a mode according to which the polarity of the nozzle electrode 160 is set to positive and the ink 200 projecting from the nozzle 151 is charged negatively upon the start of the ejection operation (see FIG. 5B), and at the timing that the main droplet 200 is severed from the ink 200A inside the nozzle 151 (see FIG. 5C), the polarity of the nozzle electrode 160 is changed to the negative polarity, and an electrostatic force of repulsion is caused to act between the negatively charged satellite droplet 202 and the nozzle electrode 160 and the nozzle plate 151A which is made of silicon.

On the other hand, it is also possible to adopt a composition according to which the charging of the nozzle electrode 160 is removed at the timing that the main droplet 200 is severed from the ink 200A in the nozzle 151. In this mode, it is possible to cause an electrostatic force of repulsion to act between the satellite droplet 202 and the negatively charged nozzle plate 151A.

According to this mode, there is no requirement to provide a power source device capable of outputting a negative voltage applied to the nozzle electrode 160, and therefore the apparatus composition is simplified.

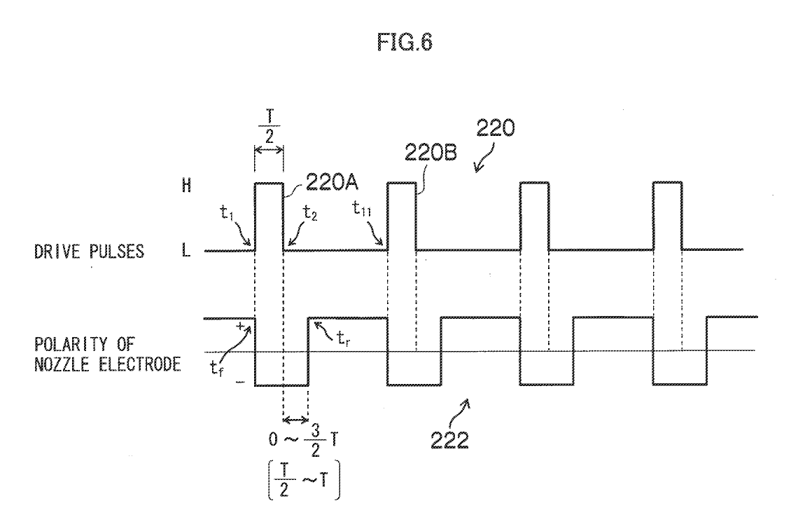

FIG. 6 is a diagram showing the relationship between the drive signal or drive pulses 220 for ejecting ink and the polarity 222 of the nozzle electrode 160. The drive pulses 220 shown in FIG. 6 are a positive logic pulse signal and the piezoelectric element 158 (see FIG. 3) is operated while this signal has level H.

At the timing t₁ that the drive pulse 220 is applied to the piezoelectric element 158 (the rising edge where the drive signal changes from the level L to the level H), the polarity 222 of the nozzle electrode 160 is switched from positive to negative. The polarity 222 of the nozzle electrode 160 is then switched from negative to positive after the timing t₂ at which the application of the drive pulse 220 is ended (after the falling edge where the drive signal changes from the level H to the level L). The polarity 222 of the nozzle electrode 160 is switched from positive to negative at the start timing t₁₁ of the next drive pulse 220. In this way, the switching of the polarity 222 of the nozzle electrode 160 is repeated in accordance with the drive pulses 220.

More specifically, by reversing the polarity 222 of the nozzle electrode 160 during the period of the ejection operation and then reversing the polarity 222 of the nozzle electrode 160 in accordance with the end timing of the ejection operation, an electrostatic force of repulsion is caused to act on the satellite droplet 202 that has been generated by the ejection of the main droplet 200. The timing t_{f} at which the polarity 222 of the nozzle electrode 160 switches from positive to negative can be within a period from the application end timing of the previous drive pulse (for example, t₂ of the drive pulse 220A) until the ejection operation start timing (for example, the application start timing t₁₁ of the drive pulse 220B), and can precede the ejection operation start timing. Since there is a time difference between the drive pulse and the actual behavior of the ink, due to the physical properties of the ink and other factors, then the timing at which the polarity 222 of the nozzle electrode 160 is switched from positive to negative can be set to a timing between the application start timing t₁ of the drive pulse 220A to the application end timing t₂ of the drive pulse 220A.

Furthermore, the timing tᵣ at which the polarity 222 of the nozzle electrode 160 is switched from negative from positive can be the timing of severance of the main droplet when the ink is ejected (see FIG. 5C). In other words, “during the time period of the ejection operation” includes a time period from the application start timing of the drive pulse in one ejection operation (for example, t₁) until the severance timing (not shown in FIG. 6) during ejection.

Here, the severance timing during ejection of the ink is included in the time period from the application end timing t₂ of the drive pulse 220A until the application start timing t₁₁ of the next drive pulse 220B. Since variations occur depending on the physical properties of the ink, the drive pulse waveform, the amplitude (voltage), and the structure of the inkjet head, it is preferable that the timing of severance during ink ejection is ascertained and set accordingly by experimentation, simulation, or the like.

In general, if the pulse width of the drive pulse is T/2 (where T is the resonance frequency of the head), then the duration from the application end timing t₂ of the drive pulse until the severance timing upon ink ejection can be equal to or greater than 0 and not greater than (3×T)/2, and more desirably, not less than T/2 and not greater than T.

The head 150 in which the nozzles 151 are arranged in the matrix configuration as shown in FIGS. 2A to 2C ejects the ink at the same timing from the nozzles 151 aligned in the main scanning direction, and therefore by arranging the nozzle electrodes 160 in the main scanning direction, it is possible to switch the polarity of the nozzle electrode 160 in accordance with the ejection timing, without complicating the arrangement of the nozzle electrodes 160, the wiring to the nozzle electrodes 160 or the control of switching of the nozzle electrodes 160.

Although FIG. 6 shows an example of the square-shaped drive pulses 220, it is also possible to use a drive waveform that combines a pull drive waveform for pulling the ink inside the nozzle 151 toward the pressure chamber 152 side, a push drive waveform which pushes the ink that has been pulled to the pressure chamber 152 side, to the exterior of the nozzle 151, and a pull drive waveform which pulls the ink that has been pushed out to the exterior of the nozzle 151, into the nozzle 151. For example, it is possible to adopt a composition whereby the polarity of the nozzle electrode 160 is reversed at the timing that the push drive waveform is switched to the second pull drive waveform.

### Modification of Nozzle Electrode

Next, a modification of the nozzle electrode 160 shown in FIGS. 2A to 2C will be described in detail.

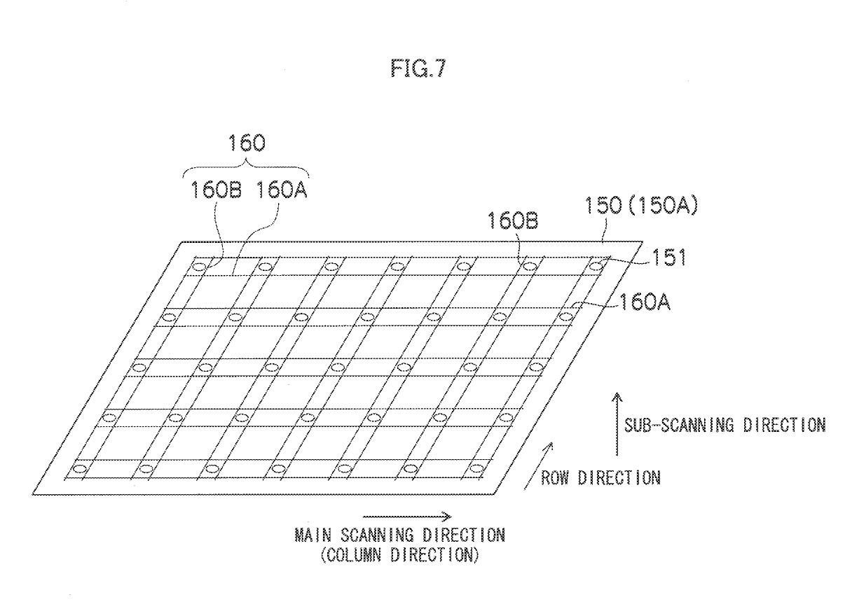

FIG. 7 is a plan diagram showing a nozzle face 150A in which nozzle electrodes 160A and 160B are arranged in a grid pattern, so as to demarcate the nozzles 151 arranged in a matrix.

The nozzle electrodes 160 in FIG. 7 are constituted of the nozzle electrodes 160A arranged in the main scanning direction, and the nozzle electrodes 160B arranged in the nozzle row direction, which forms a prescribed angle θ (see FIG. 2B) with respect to the main scanning direction (the column direction). It is possible to adopt a composition where the polarities of the nozzle electrodes 160A and the nozzle electrodes 160B are changed simultaneously, or where the polarities are switched independently.

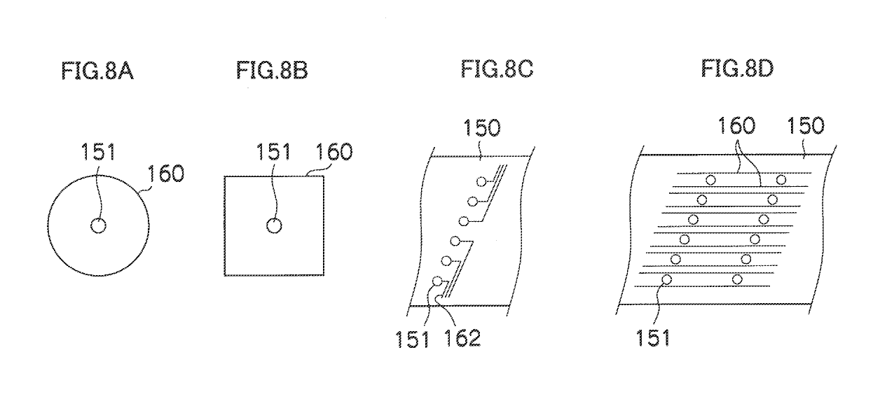

FIGS. 8A and 8B are diagrams showing embodiments where the nozzle electrodes 160 are arranged about the periphery of the nozzles 151. As shown in FIGS. 8A and 8B, if the nozzle electrodes 160 are arranged as closely as possible to the nozzles 151, adherence of satellite droplets to the nozzles 151 and the vicinity of the nozzles 151 can be prevented effectively.

FIG. 8C is a diagram showing one portion of individual wires 162, which are connected to the nozzle electrodes 160. If the nozzle electrodes 160 are arranged respectively for the nozzles 151, the individual wires 162 are connected to the respective nozzle electrodes 160 are arranged following the row direction. According to the embodiments shown in FIGS. 8A and 8B, it is possible to switch the polarities of the nozzle electrodes respectively and independently.

According to the arrangement patterns of the nozzle electrodes 160 shown in FIGS. 7, 8A and 8B, it is possible to raise the beneficial effect in preventing adherence of satellite droplets to the nozzle electrodes 160 by placing the nozzle electrodes 160 in the proximity of the nozzles 151 or surrounding the periphery of the nozzles 151 by means of the nozzle electrodes 160.

Furthermore, also in the mode shown in FIGS. 2A to 2C, by adopting a composition where the respective nozzles 151 are placed between two nozzle electrodes 160 as shown in FIG. 8D, it is possible to raise the effect of preventing adherence of satellite droplets to the nozzle electrodes 160.

### Further Embodiment of Apparatus Composition

Next, another apparatus composition to which the present invention can be applied will be described.

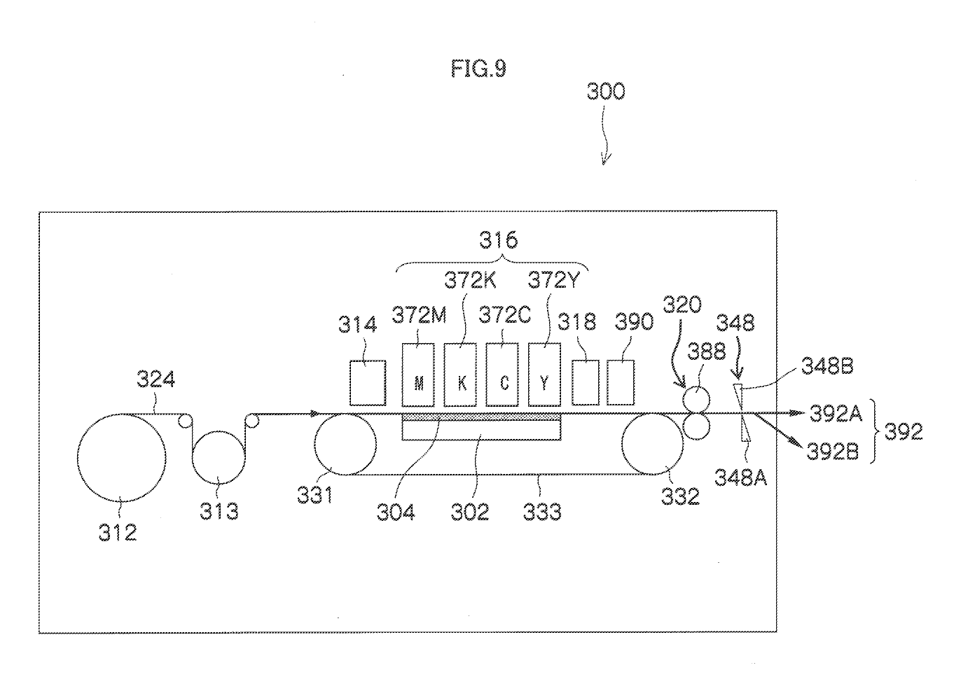

Instead of the pressure drum conveyance method shown in FIG. 1, an inkjet recording apparatus 300 shown in FIG. 9 employs a belt conveyance method in which a recording medium 324 is held and conveyed on an endless belt 333, which is wrapped about two rollers 331 and 332. Furthermore, the recording medium 324 used is continuous paper. In other words, a long recording medium 324 is drawn out from a roll 312 and subjected to a decurling process by a decurling unit 313, and a treatment liquid is deposited on the recording medium 324 by a treatment liquid deposition unit 314. Then, the recording medium 324 is conveyed to a printing region immediately below a print unit 316, which includes inkjet heads 372M, 372K, 372C and 372Y, and image recording is carried out.

The basic functions (composition) of the inkjet recording apparatus 300 shown in FIG. 9 are common with the inkjet recording apparatus 10 shown in FIG. 1, and therefore description of the common parts is omitted here as appropriate.

When image recording is carried out, a drying process is performed by a drying unit 318, and furthermore, the image is read in by an in-line sensor 390 and a fixing process is carried out by a fixing unit 320 including a fixing roller 388. The recording medium 324 that has been subjected to the fixing process is cut to a desired size by a cutter 348 constituted of a fixed blade 348A and a circular blade 348B, which moves along the fixed blade 348A, and the cut recording medium is then output to the exterior of the apparatus from an output unit 392.

The output unit 392 has output paths 329A and 329B, and is composed in such a manner that the output paths can be switched for separate orders, or in accordance with the type of images, such as regular images and test images.

The inkjet recording apparatus 300 shown in FIG. 9 includes a platen 302 for supporting the belt 333 from the opposite side of the print unit 316, directly below the print unit 316 (the inkjet heads 372M, 372K, 372C and 372Y). Furthermore, a recovery electrode 304 is arranged on the surface of the platen 302 (the surface on the belt 333 side), and a composition is adopted whereby the recovery electrode 304 is applied with a voltage of the polarity opposite to the polarity of the nozzle electrodes which are arranged on the nozzle faces of the inkjet heads 372M, 372K, 372C and 372Y (the nozzle electrodes are not shown in FIG. 9; see FIGS. 2A to 2C).

If the recovery electrode 304 is applied with the voltage of the polarity opposite to the polarity of the nozzle electrodes 160, then an electrostatic force of attraction is generated between the satellite droplets 202 (see FIGS. 5D and 5E) and the recovery electrode 304, and the satellite droplets 202 are attracted toward the recovery electrode 304.

Thus, it is possible to collect the satellite droplets 202 in the non-image region (the region between one recorded image and the next recorded image) of the recording medium (continuous paper) 324 if the recovery electrode 304 is applied with the voltage of the polarity opposite to the polarity of the nozzle electrodes 160 at the timing that printing by the print unit 316 is ended. The non-image region of the recording medium 324 upon which the satellite droplets 202 have been collected is cut by the cutter 348 and then output from an output path separately from the recorded image.

It is also possible to arrange a recovery electrode that is applied with a positive voltage and a recovery electrode that is applied with a negative voltage, separately on the surface of the platen 302. Furthermore, it is also possible to arrange a plane recovery electrode 304 over the entire surface of the platen 302, and it is also possible to pattern the recovery electrode 304 into a prescribed shape.

The ink mist recovery method described in the present embodiments displays particularly beneficial effects in the inkjet head in which the nozzles 151 are arranged at high density. For example, in an inkjet head having a nozzle arrangement density of 450 npi (nozzles per inch) or more, the arrangement pitch of the adjacent nozzles is 57 μm or less, and if the nozzle diameter is 16 μm, then the distance between the outer perimeter of one nozzle and the outer perimeter of an adjacent nozzle is 41 μm or less. Consequently, if forty (40) satellite droplets 202 of approximately 1 μm size adhere to the nozzle face 150A, then there is a concern that the satellite droplets 202 will partially close off the nozzles 151.

It is desirable that the distance between the nozzle electrode 160 and the nozzle 151 is 1 mm or less, and more desirably, not less than 5 μm and not more than 28 μm. Moreover, it is desirable that the width of the nozzle electrodes 160 is set to be not less than 1 μm and less than “the arrangement pitch with respect to the adjacent nozzles minus the nozzle diameter”. Furthermore, it is desirable that the nozzle electrode 160 is applied with a voltage of between 20 V and 10 kV with respect to the reference potential (ground potential).

In the present embodiments, the inkjet recording apparatus has been described which records a color image by ejecting and depositing color inks onto a recording medium as one example of an image forming apparatus; however, the present invention can also be applied to an image forming apparatus which forms a prescribed pattern shape on a substrate by means of a resin liquid, or the like, in order, for instance, to form a mask pattern or to print wiring of a printed wiring board.

### APPENDIX

As has become evident from the detailed description of the embodiments given above, the present specification includes disclosure of various technical ideas below.

It is preferable that an image forming apparatus comprises: an inkjet head of an on-demand ejection type having a nozzle plate in which a nozzle electrode is arranged in a vicinity of a nozzle through which liquid is ejected; and a voltage application device which makes a polarity of the nozzle electrode one of positive and negative in accordance with a start of an ejection operation of the liquid, and then switches the polarity of the nozzle electrode to an opposite polarity to the one of positive and negative in accordance with a timing of ejecting the liquid through the nozzle.

According to this aspect of the present invention, by reversing the polarity of the nozzle electrode so as to assume the same polarity as the charge polarity of the ejected liquid in accordance with the ejection timing, it is possible to make an electrostatic force of repulsion act between the nozzle electrode and the mist-like droplet that has separated from the main droplet.

The inkjet head is a liquid ejection head which ejects liquid from a nozzle provided in a nozzle plate, using an inkjet method, and one example of the composition of such a head is a mode including a liquid chamber connected to the nozzle and a pressing device which applies pressure to the liquid inside the liquid chamber. Furthermore, the liquid ejected from the inkjet head includes various liquids, such as color inks which form (record) an image on a recording medium, or a resin liquid which forms a prescribed pattern on a substrate, or the like.

The “on-demand ejection type” means a system which ejects droplets of the liquid of a required amount at a required timing from the nozzle provided in the inkjet head, and possible modes are a piezoelectric method, a thermal method or an electrostatic method, depending on the method used to apply pressure to the liquid inside the inkjet head. In the on-demand ejection method, the liquid inside the inkjet head is pressed by applying a drive pulse (drive signal) corresponding to image data, to a pressing element which corresponds to the nozzle.

The “ejection operation” is a concept ranging from the start of pressing of the liquid inside the nozzle, the projection of the liquid inside the nozzle to the exterior of the nozzle, and the separation of a droplet from the liquid projecting to the exterior of the nozzle, until the liquid projecting to the exterior of the nozzle returns to the interior of the nozzle.

One example of making the polarity of the nozzle electrode positive or negative in accordance with the start of the ejection operation is a mode where the nozzle electrode is applied with a voltage at the timing that a drive signal is applied to the pressing device which applies pressure to the liquid inside the nozzle.

A mist-like droplet is a concept including a very fine droplet having a smaller volume than the main droplet, which separates off from the main droplet ejected from the nozzle. A mist-like droplet may also be called a “satellite droplet” or “contaminating droplet”, or the like.

Preferably, the voltage application device switches the polarity of the nozzle electrodes to the opposite polarity in accordance with severance of the liquid ejected through the nozzle.

According to this mode, by switching the polarity of the nozzle electrode to the same polarity as the charge polarity of the mist-like droplet, immediately after the generation of the mist-like droplet, it is possible to prevent the mist-like droplet floating in the vicinity of the nozzle from approaching the nozzle plate.

The “severance of the liquid” is a state where the leading end portion of a pillar of the liquid projecting to the exterior of the nozzle has separated off from the liquid pillar and has formed a droplet.

Preferably, the nozzle electrode has a shape of surrounding a periphery of the nozzle.

According to this mode, by surrounding the periphery of the nozzle with the nozzle electrode, it is possible to prevent the mist-like droplet from adhering to the vicinity of the nozzle opening section which is surrounded by the nozzle electrode.

The shape of the nozzle electrodes according to this mode should be a closed curve, and may adopt various different shapes, such as a circle, an ellipse or a polygon.

Preferably, the nozzle is placed between a plurality of nozzle electrodes.

According to this mode, by disposing the nozzle electrodes about the periphery of the nozzle, the adherence of mist to the vicinity of the nozzle can be prevented more effectively.

Preferably, the nozzle electrode is arranged on a liquid ejection face of the nozzle plate from which the liquid is ejected, and is covered with an insulating film having insulating properties.

According to this mode, it is possible to ensure the insulating properties of the nozzle electrode.

It is also preferable that the nozzle electrode is arranged on a face of the nozzle plate opposite to a liquid ejection face from which the liquid is ejected.

According to this mode, the insulating properties of the nozzle electrode can be ensured without covering the nozzle electrode with a protective film, and therefore the protective film is not necessary.

Preferably, the nozzle plate contains silicon, and the voltage application device makes the polarity of the nozzle electrode negative in accordance with the start of the ejection operation of the liquid, and then switches the polarity of the nozzle electrode to positive in accordance with the timing of ejecting the liquid through the nozzle.

According to this mode, since silicon has properties which allow it to be easily charged to a negative polarity, and since the liquid is charged positively when passing through the nozzle and the mist-like droplet that has separated off from the droplet after ejection are also charged positively, then an electrostatic force of repulsion acts on the mist-like droplet when the polarity of the nozzle electrode is switched from negative to positive in accordance with the timing of ejecting the liquid through the nozzle, and the mist-like droplet can be prevented from adhering to the nozzle plate.

It is also preferable that the nozzle plate contains silicon, and the voltage application device makes the polarity of the nozzle electrode positive in accordance with the start of the ejection operation of the liquid, and then switches the polarity of the nozzle electrode to negative in accordance with the timing of ejecting the liquid through the nozzle.

According to this mode, since the droplet after ejection and the mist-like droplet that has broken off from the droplet are negatively charged, then an electrostatic force of repulsion acts between the mist-like droplet and the nozzle plate, which is made of silicon that is readily charged to a negative polarity, and the nozzle electrode the polarity of which has been switched to negative, and therefore the mist-like droplet can be prevented from adhering to the nozzle plate.

It is also preferable that the nozzle plate contains silicon, and the voltage application device makes the polarity of the nozzle electrode positive in accordance with the start of the ejection operation of the liquid, and then removes charge of the nozzle electrode in accordance with the timing of ejecting the liquid through the nozzle.

According to this mode, an electrostatic force of repulsion acts between the mist-like droplet that is negatively charged and the silicon nozzle plate which is readily charged to a negative polarity, and adherence of the mist-like droplet to the nozzle plate can be prevented. Furthermore, there is no need to apply a negative voltage to the nozzle electrode and hence the apparatus composition is simplified.

Preferably, the image forming apparatus further comprises a liquid charging device which charges a main droplet of the liquid after ejection through the nozzle to a polarity opposite to a polarity during the ejection.

According to this mode, since the charge polarity of the main droplet and the charge polarity of the mist-like droplet are opposite, then an electrostatic force of attraction acts between the main droplet and the mist-like droplet, and the mist-like droplet can be made to unite with the main droplet.

Preferably, the inkjet head has a plurality of nozzles arranged at a density of at least 450 nozzles per inch.

According to this mode, although the inkjet head having the nozzles arranged at a high density of 450 nozzles per inch or more has a high possibility of producing ejection abnormalities due to the adherence of mist-like droplets to the nozzle plate, it is possible to suppress the occurrence of ejection abnormalities of this kind.

One example of a nozzle arrangement in this mode is a matrix configuration in which the nozzles are arranged in a two-dimensional configuration following a row direction along the main scanning direction and a column direction that is oblique to the sub-scanning direction.

Preferably, the image forming apparatus further comprises: a conveyance device which conveys the inkjet head and a recording medium on which a prescribed image is formed by the liquid ejected through the nozzle, relatively with each other in a conveyance direction; and an ejection control device which controls the ejection of the liquid from the inkjet head, wherein: the inkjet head has a structure of a plurality of nozzles arranged so as to correspond to a dimension of the recording medium in a sub-scanning direction which is substantially perpendicular to the conveyance direction of the conveyance device, and the ejection control device controls the ejection of the liquid from the inkjet head so as to form a desired image on the recording medium by relatively conveying the recording medium and the inkjet head only once.

In the inkjet head having the nozzles arranged in the matrix configuration, if ejection abnormalities occur when forming an image using a single-pass method, stripe-shaped non-uniformities following the conveyance direction of the recording medium are visible. Ejection abnormalities in nozzles which are the cause of deterioration in image quality of this kind can be prevented effectively.

Preferably, the inkjet head has a structure in which the plurality of nozzles are arranged in a matrix configuration in a row direction substantially perpendicular to the conveyance direction of the conveyance device and in a column direction oblique to the row direction; and the nozzle electrode is arranged in one of a direction following the row direction corresponding to the nozzles aligned in the row direction, and a direction following the column direction corresponding to the nozzles aligned in the column direction.

According to this mode, with respect to the nozzles which carry out the ejection operation at the same timing, the switching the polarity of the nozzle electrodes simultaneously, and it is then possible reliably to prevent the adherence to the nozzle plate of mist-like droplets which are floating in the vicinity of the nozzles.

Preferably, the nozzle electrode is arranged in both the row direction and the column direction so as to demarcate the nozzles.

In this mode, it is possible to control the nozzle electrode for each row or each column, independently.

Preferably, the conveyance device is provided with a recovery electrode to which a voltage of a polarity opposite to the polarity of the nozzle electrode is applied in accordance with the timing of ejecting the liquid through the nozzles.

According to this mode, an electrostatic force of attraction acts between the mist-like droplet and the recovery electrode, and the mist-like droplet can be recovered to the vicinity of the recovery electrode.

Preferably, the conveyance device is provided with a positive recovery electrode and a negative electrode to which a positive voltage and a negative voltage are respectively applied in accordance with the timing of ejecting the liquid through the nozzles.

According to this mode, a composition is adopted whereby, when the mist-like droplet is positively charged, the negative recovery electrode is used and when the mist-like droplet is negatively charged, the positive recovery electrode is used.

It is also preferable that a mist recovery method comprises the steps of: making a polarity of a nozzle electrode one of positive and negative in accordance with a start of an ejection operation of liquid through a nozzle in an inkjet head of an on-demand ejection type, the nozzle electrode being arranged in a vicinity of the nozzle; and then switching the polarity of the nozzle electrode to an opposite polarity to the one of positive and negative in accordance with a timing of ejecting the liquid through the nozzle.

Preferably, the switching step is carried out in accordance with severance of the liquid ejected through the nozzle.

Preferably, the mist recovery method further comprises the step of charging a main droplet of the liquid after ejection through the nozzle to a polarity opposite to a polarity during the ejection.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus, comprising:
an inkjet head of an on-demand ejection type having a nozzle plate in which a nozzle electrode is arranged in a vicinity of a nozzle through which liquid is ejected; and
a voltage application device which makes a polarity of the nozzle electrode one of positive and negative in accordance with a start of an ejection operation of the liquid, and then switches the polarity of the nozzle electrode to an opposite polarity to the one of positive and negative in accordance with a timing of ejecting the liquid through the nozzle.

2. The image forming apparatus as defined in claim 1, wherein the voltage application device switches the polarity of the nozzle electrodes to the opposite polarity in accordance with severance of the liquid ejected through the nozzle.

3. The image forming apparatus as defined in claim 1, wherein the nozzle electrode has a shape of surrounding a periphery of the nozzle.

4. The image forming apparatus as defined in claim 1, wherein the nozzle is placed between a plurality of nozzle electrodes.

5. The image forming apparatus as defined in claim 1, wherein the nozzle electrode is arranged on a liquid ejection face of the nozzle plate from which the liquid is ejected, and is covered with an insulating film having insulating properties.

6. The image forming apparatus as defined in claim 1, wherein the nozzle electrode is arranged on a face of the nozzle plate opposite to a liquid ejection face from which the liquid is ejected.

7. The image forming apparatus as defined in claim 1, wherein:
the nozzle plate contains silicon, and
the voltage application device makes the polarity of the nozzle electrode negative in accordance with the start of the ejection operation of the liquid, and then switches the polarity of the nozzle electrode to positive in accordance with the timing of ejecting the liquid through the nozzle.

8. The image forming apparatus as defined in claim 1, wherein:
the nozzle plate contains silicon, and
the voltage application device makes the polarity of the nozzle electrode positive in accordance with the start of the ejection operation of the liquid, and then switches the polarity of the nozzle electrode to negative in accordance with the timing of ejecting the liquid through the nozzle.

9. The image forming apparatus as defined in claim 1, wherein:
the nozzle plate contains silicon, and
the voltage application device makes the polarity of the nozzle electrode positive in accordance with the start of the ejection operation of the liquid, and then removes charge of the nozzle electrode in accordance with the timing of ejecting the liquid through the nozzle.

10. The image forming apparatus as defined in claim 1, further comprising a liquid charging device which charges a main droplet of the liquid after ejection through the nozzle to a polarity opposite to a polarity during the ejection.

11. The image forming apparatus as defined in claim 1, wherein the inkjet head has a plurality of nozzles arranged at a density of at least 450 nozzles per inch.

12. The image forming apparatus as defined in claim 1, further comprising:
a conveyance device which conveys the inkjet head and a recording medium on which a prescribed image is formed by the liquid ejected through the nozzle, relatively with each other in a conveyance direction; and
an ejection control device which controls the ejection of the liquid from the inkjet head, wherein:
the inkjet head has a structure of a plurality of nozzles arranged so as to correspond to a dimension of the recording medium in a sub-scanning direction which is substantially perpendicular to the conveyance direction of the conveyance device, and
the ejection control device controls the ejection of the liquid from the inkjet head so as to form a desired image on the recording medium by relatively conveying the recording medium and the inkjet head only once.

13. The image forming apparatus as defined in claim 12, wherein:
the inkjet head has a structure in which the plurality of nozzles are arranged in a matrix configuration in a row direction substantially perpendicular to the conveyance direction of the conveyance device and in a column direction oblique to the row direction; and
the nozzle electrode is arranged in one of a direction following the row direction corresponding to the nozzles aligned in the row direction, and a direction following the column direction corresponding to the nozzles aligned in the column direction.

14. The image forming apparatus as defined in claim 13, wherein the nozzle electrode is arranged in both the row direction and the column direction so as to demarcate the nozzles.

15. The image forming apparatus as defined in claim 12, wherein the conveyance device is provided with a recovery electrode to which a voltage of a polarity opposite to the polarity of the nozzle electrode is applied in accordance with the timing of ejecting the liquid through the nozzles.

16. The image forming apparatus as defined in claim 12, wherein the conveyance device is provided with a positive recovery electrode and a negative electrode to which a positive voltage and a negative voltage are respectively applied in accordance with the timing of ejecting the liquid through the nozzles.

17. A mist recovery method, comprising the steps of:
making a polarity of a nozzle electrode one of positive and negative in accordance with a start of an ejection operation of liquid through a nozzle in an inkjet head of an on-demand ejection type, the nozzle electrode being arranged in a vicinity of the nozzle; and
then switching the polarity of the nozzle electrode to an opposite polarity to the one of positive and negative in accordance with a timing of ejecting the liquid through the nozzle.

18. The mist recovery method as defined in claim 17, wherein the switching step is carried out in accordance with severance of the liquid ejected through the nozzle.

19. The mist recovery method as defined in claim 17, further comprising the step of charging a main droplet of the liquid after ejection through the nozzle to a polarity opposite to a polarity during the ejection.
